(19) United States
(12) Patent Application Publication
(10) Pub. No.: US 2014/0019155 A1
(43) Pub. Date: Jan. 16, 2014

(54) SYSTEMS AND METHODS FOR HEALTHCARE COST MANAGEMENT

(71) Applicant: ConSova Corporation, Lakewood, CO (US)

(72) Inventor: Michael D. Smith, Arvada, CO (US)

(21) Appl. No.: 13/942,178

(22) Filed: Jul. 15, 2013

Related U.S. Application Data
(60) Provisional application No. 61/671,424, filed on Jul. 13, 2012.

(51) Int. Cl. G06Q 30/04; G06Q 50/22

(52) U.S. Cl. CPC G06Q 30/04; G06Q 50/22
USPC 705/2

(57) ABSTRACT

Implementations described and claimed herein provide systems and methods for healthcare cost management. In one implementation, information is imported into a database using a network component. The information relates to a claim involving medical services billed by a provider for a consumer. The consumer is prompted to review an accuracy of one or more items of the billed medical services. An initial review of the accuracy of the one or more items by the consumer is received at a server. The initial review identifies whether the one or more items correspond to actual services performed by the provider. The claim is verified based on the initial review. The verification dictates whether an inquiry is sent to the provider regarding the claim.

### CROSS-REFERENCE TO RELATED APPLICATIONS

The present application claims priority under 35 U.S.C. §119(e) to U.S. Provisional Patent Application No. 61/671,424, entitled “Systems and Methods for Healthcare Cost Management,” filed on Jul. 13, 2012, which is hereby incorporated by reference herein in its entirety.

### TECHNICAL FIELD

Aspects of the present disclosure relate to healthcare cost management services and more particularly to healthcare cost containment by providing mechanisms for verifying benefits, among other functions.

### BACKGROUND

The healthcare system is an increasingly unclear and cumbersome ecosystem for patients to navigate. Healthcare providers, such as physicians and hospitals, generally provide limited billing information that is often difficult for a typical patient to understand. One particular source of confusion results from a lack of transparency in billing processes and reimbursement methodologies, including the medical coding used to determine provider reimbursement. The use of numerous, often vague, medical codes by providers fosters an environment of confusion and ambiguity as a patient attempts to determine whether the medical services being billed by a provider correctly correspond to the actual services performed for the patient. This confusion and ambiguity often results in elevated medical costs as reimbursement is provided for services that were not actually rendered. Moreover, with the involvement of insurance providers, there is often little direct incentive for a patient to confirm services were properly billed particularly when the nature of the billing process itself involves difficult to unravel ambiguities.

It is with these observations in mind, among others, that various aspects of the present disclosure were conceived and developed.

### SUMMARY

Implementations described and claimed herein address the foregoing problems, among others, by providing systems and methods for verifying benefits and healthcare cost management. In one implementation, information is imported into a database using a network component. The information relates to a claim involving medical services billed by a provider for a consumer. The consumer is prompted to review the accuracy of one or more items of the billed medical services. An initial review of the accuracy of the one or more items by the consumer is received at a server. The initial review identifies whether the one or more items correspond to actual services performed by the provider. The claim is verified based on the initial review. The verification dictates whether an inquiry is sent to the provider regarding the claim.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 is an example medical cost management system, including a medical cost management application running on a computer server or other similar device coupled with a network, for benefit verification.

FIG. 2 shows an example learning module.

FIG. 3 illustrates an example claim verification module.

FIG. 4 is a flow chart illustrating example operations for claim data verification.

FIG. 5 is a flow chart illustrating example operations for verifying a claim.

FIG. 6 shows an example subscriber user interface generated by the medical cost management application, the user interface being displayed in a browser window of a computing device and displaying a summary of patient claim verifications.

FIG. 7 depicts the user interface showing claim inventory.

FIG. 8 shows the user interface displaying a claim review.

FIG. 9 illustrates a provider user interface for capturing a provider response.

FIG. 10 shows a window on the subscriber user interface for updating a claim.

FIG. 11 is an example of a computing system that may implement various systems and methods discussed herein.

### DETAILED DESCRIPTION

Aspects of the present disclosure involve systems and methods for managing healthcare costs and are directed toward the protection and promotion of patient interests by increasing the accountability of healthcare providers. This is accomplished, in part, by providing patients with the information, assistance, and platform to be active and informed participants in the healthcare system.

In one particular aspect, an interactive medical cost management system provides a subscriber with a secure, personalized user interface presenting healthcare benefit claims that were paid by the subscriber's health plan. Such claims may include claims relating to services performed for the subscriber and/or participating dependents. The subscriber is prompted to review and verify the accuracy of each billed service, supply, device, or other item in a claim and to review all itemized sections of a claim to verify whether the sections correspond to the services rendered by the provider. The subscriber may agree with the items billed or submit an inquiry, requesting additional information or correction of the items billed. The subscriber is encouraged to keep track of such inquiries through resolution. To assist the subscriber, the system tracks the subscriber's inquiries and is notified, through various possible electronic mechanisms including alerts, email, and the like, of events related to any given inquiry.

The medical cost management system uses medical code conversion data provided in a medical code conversion table or database to simplify review of medical bill information. To facilitate review for verifying provider reimbursement, medical codes are interpreted and may be illustrated in a manner understandable by subscribers. The code interpretation information is linked to paid medical claims data received from a healthcare plan or payer to facilitate medical claim information verification. For example, such linked information may be used to determine whether medical services were performed or billed correctly. Stated differently, the system translates billing information into a subscriber friendly form so that the subscriber may more efficiently confirm or question the billing.

The medical cost management system assists subscribers as they navigate the complexity of healthcare billing information via educational opportunities. For example, one or more learning modules and/or knowledge base/reference modules may be utilized to enable the subscriber to acquire and assess healthcare knowledge. The educational opportunities guide the subscribers through the interactive verification of benefits through multiple delivery methods depending, for example, on the proficiency level of the subscriber, the frequency of use by the subscriber, preferences of the subscriber or the health plan or payer, user feedback, claim specific issues, or other subscriber or claim related issues.

Subscribers may be incentivized to engage in benefit verification and cost management through a rewards program, such as a point-based reward program or one-time reward. Thus, unlike some conventional systems, the present system may facilitate the ease of review and confirmation of services, and provide the subscriber with incentives to use the system. The rewards program allocates points or assigns rewards based on actions performed by the subscriber or participating patient. The rewards program may be tied to direct incentive health plans or payers, such as through health plan premium reductions, increased health savings account (HSA) contributions or health reimbursement account (HRA) contributions.

The medical cost management system may collect, parse, and interpret data to provide an analysis or audit of subscriber or provider conduct. For example, an auditing tool and/or costs analysis tool may provide information from which a subscriber may select an economical provider to reduce healthcare costs. Further, the data may be used to determine whether a particular provider: makes billing mistakes often; resolves billing mistakes timely; fails to resolve billing mistakes; fails to respond to subscriber requests; or engages in other noteworthy conduct. This information may be useful in determining whether to include a provider in a health plan and to encourage providers to engage with subscribers to resolve issues, among other benefits

The medical cost management system may provide employers or payers with: an overview of participation, claim verification, and education activity; aggregated data; and/or the ability to self-customize the services to best fit the needs of the subscribers and the organization. Further, providers may utilize a provider user interface to respond to a subscriber inquiry.

In general, aspects of the present disclosure encourage patients to become more involved in the financial impacts of their consumption in the healthcare system and provide the education, tools, and assistance for patients to actively verify and resolve provider-billed services for which their healthcare plan has paid. The various systems and methods disclosed herein provide for the management of healthcare costs. The example implementation discussed herein references the verification and resolution of provider-billed services. However, it will be appreciated by those skilled in the art that the presently disclosed technology is applicable to other types of healthcare cost data and management services.

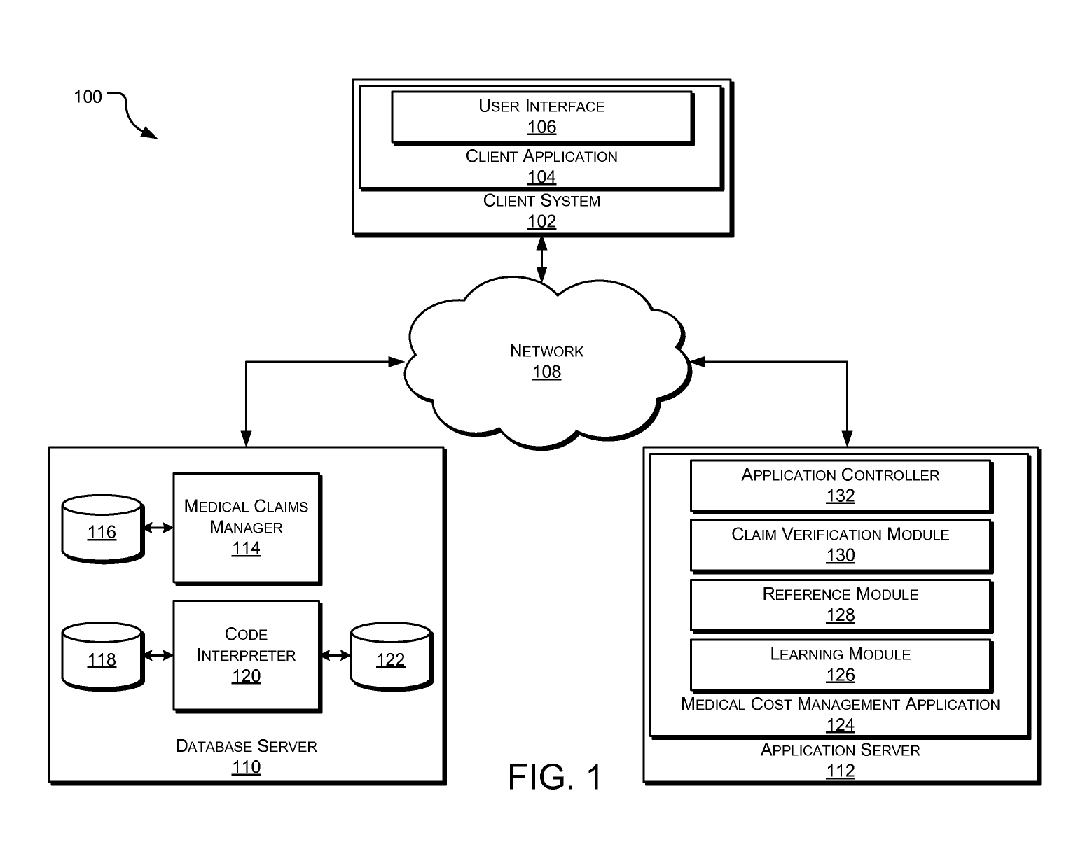

Referring to FIG. 1, an example medical cost management system 100 is shown. In one implementation, the system 100 includes a client system 102 configured to execute a client application 104 to provide a user interface 106 for accessing and interacting with services running on a computer server or other similar device coupled with a network 108 (e.g., the Internet).

The network 108 is used by one or more computing or data storage devices (e.g., a database server 110 and an application server 112) for implementing the system 100. A user, such as a subscriber, employer, payer, provider, or other interested party, may access and interact with the database server 110 and/or the application server 112 using the client system 102 via the network 108. The client system 102 is generally any form of computing device capable of interacting with the network 108, such as a personal computer, workstation, portable computing device, mobile phone device, a tablet, a multimedia console, etc.

In one implementation, the network 108 includes a server hosting a website or an application that a user may visit to access and interact with the database server 110 and/or the application server 112. In one possible example, the client system is running a web browser and accesses the server 112 at a network address entered in the browser. The servers may be single servers, a plurality of servers with each such server being a physical server or a virtual machine, or a collection of both physical servers and virtual machines. In another implementation, a cloud hosts one or more components of the system 100. The client system 102, the database server 110 and the application server 112, and other resources connected to the network 108 may access one or more other servers to access to one or more websites, applications, web services interfaces, storage devices, computing devices, etc. that are used to manage healthcare costs. The server may also host a search engine that the system 100 uses for accessing and modifying cost information.

As can be understood from FIG. 1, in one implementation, the database server 110 includes a medical claims database management system 114 for managing a medical claims database 116. The medical claims database includes information pertaining to claims paid on behalf of a subscriber. The database server also includes a medical code interpretation application 120 for interpreting or otherwise converting medical codes stored in a medical codes database 122 based on information stored in a medical code interpretation database 118. Stated differently, the medical codes database identifies the myriad of different possible medical codes pertaining to the various possible paid claims. The interpretation database includes subscriber friendly information pertaining to some or all of the codes, which subscriber friendly information may include one or more plain-English translations of the code, diagrams explaining procedure, diagrams illustrating a device, information pertaining to brand names for generic drugs, and other information helpful in understanding the service, treatment, etc., pertaining to a code on a bill.

In one implementation, the application server 112 hosts a medical costs management application 124 that the client server 102 may access to manage medical costs and perform other functions. The medical costs management application 124 may include a plurality of modules for managing healthcare costs. For example, the medical costs management application 124 may include a learning module 126, a reference module 128, and a claim verification module 130. Generally speaking, the application server is in communication with the database server in order to use and process information stored in the various databases.

In one implementation, the application server 112 includes an application controller 132 configured to control access to the medical costs management application 124. The application controller 132 processes user commands and data received via the user interface 106 of the client system 102. For example, the application controller 132 may control access to the application server 112 by requiring a user to create or log into a secured account through the client application 104. Further, the application controller 132 may identify an appropriate application to process data entered by a user via the user interface 106. In one implementation, the application controller 132 controls the execution of the various modules included in the medical costs management application 124, including the learning module 126, the reference module 128, and the claim verification module 130.

The learning module 126 is configured to provide subscribers with sufficient knowledge to maximize their benefit from the medical costs management application 124 and increase their sophistication as consumers of health services. Stated differently, the learning module 126 assists subscribers as they navigate the complexity of healthcare billing information. Further the learning module 126 provides opportunities for subscribers to test their knowledge, for example, to meet requirements by health plans or payers, participate in a rewards program, and/or identify where further information or education is needed or desired.

The reference module 128 is configured to provide subscribers with content that may be used as a reference for verifying medical procedures and acquiring knowledge about medical treatments and care. The reference module 128 and/or the learning module 126 help inform healthcare consumers so that they can be capable of managing and understanding the financial impacts of their consumption in the healthcare system. In one implementation, the reference module 128 includes information including, The Consumers Medical Terminology guide and Medical Auditor's guide, and functionality enabling the referencing of information on various agency or organization websites, applications, or resources and the searching of terminology within medical databases or other databases or the Web generally (e.g., ConSova™, WedMD™, Google™, or the like). In one implementation, the reference module 128 includes information to assist in the education of the subscriber regarding other cost saving opportunities. For example, the reference module 128 may provide information regarding the potential savings for using: an in-network provider as compared to an out-of-network provider; home treatments versus office or hospital treatments; and generic medication as compared to branded or mail order medication.

The claim verification module 130 is configured to provide the subscriber with a simplified and interactive review and verification of billing information included in the subscriber medical claim record. In one implementation, the claim verification module 130 identifies and displays healthcare benefit claims that were paid by the health plan. Such claims may include claims relating to services performed for the subscriber and/or participating dependents of the subscriber. The claims may be reviewed and verified by the subscriber or the participating dependents for their own provider-billed claims.

Using these modules, among others, the medical costs management application 124 provides a user friendly subscriber interface for consumers (e.g., subscribers or their dependents) to acquire healthcare system knowledge through guided activities. The activities introduce the medical costs management application 124 and provide detailed instructions for how to maximize the use of the medical costs management application 124. For example, video slide show presentations with interactive user control and participation and various levels of concept complexity and research tools may be provided.

Further, the medical costs management application 124 provides an intuitive benefit verification platform to assist the consumer in understanding and confirming the validity of the billed healthcare services and in navigating the process of requesting additional information or corrections from the provider when necessary or desired. Stated differently, the medical costs management application 124 prompts the consumer to review and verify the accuracy of each billed service, supply, device, or other item in a claim and to review all itemized sections of a claim to verify whether the sections correspond to the services rendered by the provider. The consumer may agree with the items billed or submit an inquiry, requesting additional information or correction of the items billed. The medical costs management application 124 assists the consumer in keeping track of such inquiries through resolution. As such, the medical costs management application 124 serves as a simple inventory management tool providing easy access to claims and high level activity and inventory summaries for consumers to manage their healthcare expenditure.

In one implementation, the medical costs management application 124 provides a provider with a provider interface for responding to consumer claim requests through an electronic response tool, for example, as an alternative to a traditional mailed letter or phone call response. The provider may be directed to the electronic response tool via the inquiry (e.g., request for correction or information) submitted to the provider on behalf of the consumer. In one implementation, the provider enters a case number and pin number as provided in the inquiry into the electronic response tool to verify and retrieve information relating to the inquiry. The medical costs management application 124 enables the provider to submit information, including, but not limited to, a contact name, a contact phone number, a response type (e.g., agree with consumer, partially or in full, or disagree with consumer), comments, supporting documents, and any charge reductions or refunds, including a check number and date. Upon receipt of the provider response, the medical costs management application 124 may notify the consumer that the response was received and/or is ready to review.

In one implementation, the medical costs management application 124 provides an employer (i.e., the person or entity operating employee health plan(s) for the subscriber) with summarizations of employee activities and information. For example, the medical costs management application 124 may provide employers with an overview of: participation rates; trending information including period-specific participation level change statistics by count and percentage by consumer type; claim verification activity; demographic makeup; and education activity and achievement level. Further, the medical costs management application 124 may provide ad hoc reporting, including simplified financial impact statements highlighted achieved plan benefits and requests for information, and administrative and configuration capabilities, such as the ability to self-customize the services to best fit the needs of the employees and the organization.

In performing administrative and configuration operations, the employer or other administrator may utilize the medical costs management application 124 to provide eligibility files, disseminate a plan message to consumers, and establish settings, for example, relating to notifications and reward plans. In one implementation, the medical costs management application 124 permits the employer to create and manage administrative accounts, provide plan guidelines for eligible consumers, access tools, such as a secure file transfer tool, and establish or edit participation guidelines. Using the medical costs management application 124, the employer may configure various elements of a custom program, including, without limitation, days until a termed user access run-out, days until user inactive classification after last activity, monetary or other threshold for charges requiring consumer verification; notifications relating to non-participating dependents.

In one implementation, the medical costs management application 124 enables the activation, creation, and managing of a rewards program, including point-based rewards plans and one-time rewards, for incentivizing consumers to participate in the management of their healthcare costs. The rewards programs may be for a specific time period or an entire plan year. The medical costs management application 124 may provide a summary listing prior offered rewards plans to assist in the creation of a new rewards plan. In one implementation, the rewards program settings include reward point categories (e.g., relating to consumer activities) and corresponding point values and/or point multipliers. In one implementation, the employer may set whether points earned from prior rewards programs carry over and/or convert to a new scale.

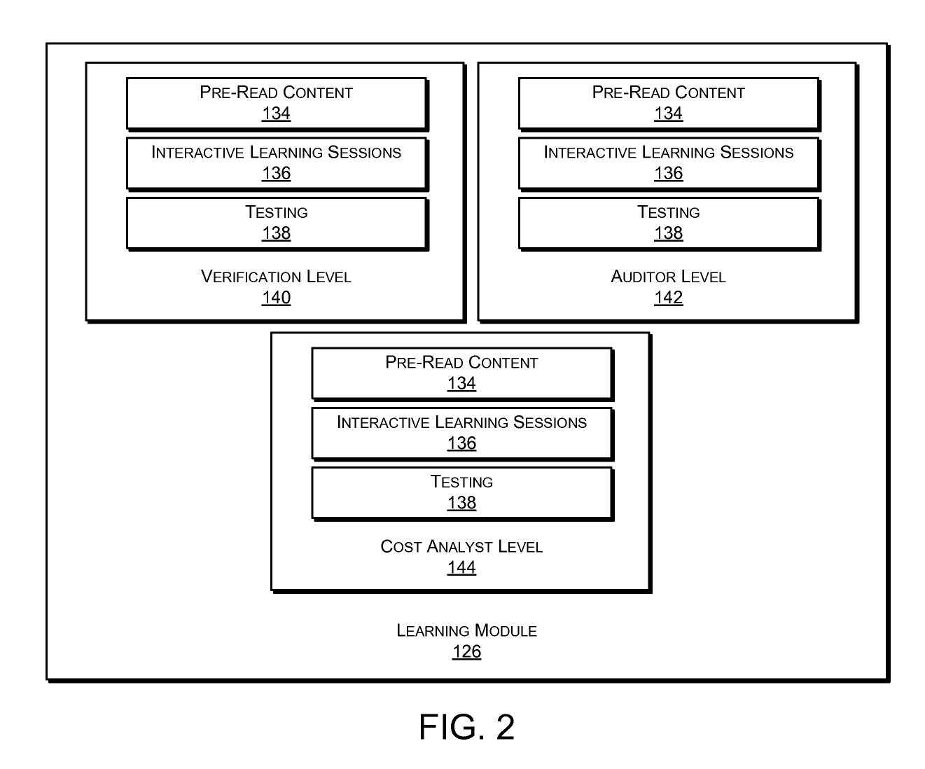

For a detailed description of the learning module 126, reference is made to FIG. 2. In one implementation, the learning module 126 provides educational opportunities that guide consumers through the interactive verification of benefits through multiple delivery methods depending, for example, on the proficiency level of the consumer, the frequency of use by the consumer, preferences of the consumer, employer, or payer, user feedback, claim specific issues, or other consumer or claim related issues. In one implementation, the learning module 126 introduces consumers to the medical costs management application 124 and a variety of healthcare billing and administrative concepts, including, without limitation, current applicable laws or standards, healthcare system basics, billing codes and practices, healthcare claim life cycles, and the like. For example, such concepts may focus on: legal and professional standards involving patient rights, privacy and protection, and dispute resolution processes; charge entry, coding, and submission; bill types, revenue codes, procedure codes and modifiers, and Healthcare Common Procedure Coding codes and modifiers; and review, calculation, and payment of claims. The consumer may achieve higher levels of understanding, skills, and access to higher levels of training.

As can be understood from FIG. 2, in one implementation, the learning module 126 includes pre-read content 134, interactive learning sessions 136, and testing 138 sections that may be based on a consumer's scope of engagement or a proficiency level the consumer would like to achieve, for example, as specified during an enrollment process. Thus, for example, a consumer interested in using the system 100 to verify billed services would enroll at a system verification level 140 and would be provided with learning content relevant to the level of enrollment. On the other hand, a consumer interested in achieving additional savings based on claim auditing knowledge or in actively using cost information stored in the system 100, for example, to select an economic provider, would enroll at higher proficiency levels, such as an auditor level 142 or a cost analyst level 144, respectively, and would be provided with appropriate training to reach the desired proficiency level.

In one implementation, the pre-read content section 134 provides an explanation of the various elements contained in the billing statement received by a health care consumer or patient. Stated differently, the pre-read content section 134 includes information useful in making an accurate determination as to whether the services were actually rendered on a particular day. More specifically, definitions or meaning of various medical or health service related terms, such as for example, “inpatient,” “outpatient,” among many others may be explained to aid patients in the billing verification process.

The learning module 126 may periodically assess and provide consumers with a rating level that reflects their current healthcare knowledge or proficiency level depending on consumer participation and test scores. For example, the assessment may be provided through the testing section 138 of the learning module 126. According to one implementation, the assessment of a consumer's knowledge can be done in such areas as basic medical terminology, advanced medical terminology, medical reimbursement guidelines, common practices used by providers to inflate reimbursement, and audit techniques to detect overpaid claims, among others.

In one implementation, the amount of detail provided during the claim verification process corresponds to the knowledge level of the consumer determined based on educational activities, achievements, and/or information provided by the consumer.

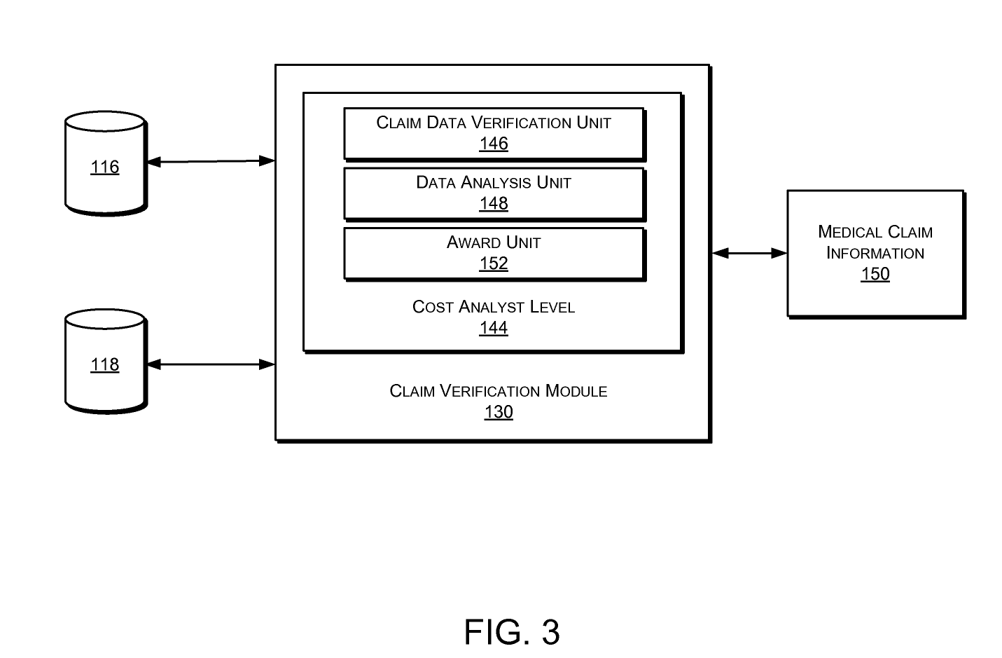

Turning to FIG. 3, the claim verification module 130 is shown. In one implementation, the claim verification module 130 provides consumers with easy to interpret medical services information to facilitate the medical service verification process. In particular, the claim verification module 130 uses a claim data verification unit 146 to integrate, join, or otherwise link code interpretation/conversion data from a code interpretation/conversion data table or database 118 to medical claims data received from a healthcare plan or payer. More specifically, medical claims data stored in a medical claims database 116 that was previously entered or otherwise provided through a data feed, may be integrated, joined or linked to code interpretation/conversion data in order to present medical claims information 150 in a format that would allow the healthcare user to determine with relative ease whether or not medical services were performed and billed correctly. An award unit 152 may collect and aggregate reward or other award information and correlate the information with medical services in presenting the medical claims information 150.

According to one implementation, the linking or joining of data may initially involve linking of the consumer to a subscriber number previously created by an employer or a health care payer. The consumer may be prompted to provide a subscriber number during the registration process in order to match the subscriber field to claims data received daily, weekly, monthly, or on some other interval from the healthcare payer. The linking or joining of data may also involve linking of the service codes included in the received medical claim records to the code interpretation/conversion data with medical service or billing codes serving as keys for matching the codes provided in the medical interpretation/conversion database 118.

In one implementation, the medical claims information 150 includes an interpretation of medical coding used to determine provider reimbursement following the integration, joining or linking process. In particular, the medical claims information 150 may include paid medical claim data for a claim submitted by a healthcare provider along with medical billing interpretation information. The paid medical claim data may include information related to a consumer, such as subscriber name and ID number, as well as a provider name and ID number. Modifiers, dates of service and date paid, billed and paid amounts as well as any post pay adjustments, adjustment coding, co-pay, coinsurance and deductible amounts may also be included in the medical claims information 150, among other information. In the case of hospital billing, date and time of discharge, as well as a bill “type” code may be included. Furthermore, each record may include medical coding used to determine provider reimbursement. Such coding may include CPT (Current Procedural Terminology), HCPC (Healthcare Common Procedure Coding System), Modifier, Revenue, ICD (International Classification of Diseases) and DRG (Diagnostic Related Group) codes.

The medical billing interpretation information may include an easy to understand description of the service in the medical claims information 150. In one implementation, the medical code interpretation/conversion information may include, among other things, a simple explanation of the nature of a service or procedure that was performed based on the billing code submitted by the provider. Thus, for example, a CPT Code of 33735 used by a provider to bill for an atrial septectormy or septostomy procedure, may include a simple description of the procedure, mainly that the procedure was designed to treat a condition of the heart that could be life threatening, as well as that it consisted of heart surgery involving the creation of a hole between the atria (between the upper two chambers of the hear). a Here, the subscriber may not necessarily know the technical term for their procedure but would know whether or not the patient had heart surgery and that a hole was made in the heart to interconnect the atria. In another implementation, images of the treated area are included in the medical claims information 150 to further simplify the verification process. Continuing with the example of a septostomy, a picture of the heart may also be provided and it may highlight the location of the atria and may show the surgically created hole. Although the billing interpretation process is discussed with reference to one specific medical procedure, it should be understood the interpretation process could be applied to billings of any medical procedure or service rendered by a provider or a hospital.

Following the claim conversion/interpretation process, the consumer may be provided with an option to access the joined data in order to verify services billed by their provider. According to one implementation, the consumer may receive an appropriate notification regarding availability of the interpreted/converted record and begin making preliminary determinations regarding the billed services thereafter. Designations made for all of the billed services during the initial verification process may be submitted for further analysis, and a summary of all initial dispositions along with any identified discrepancies may be noted and provided to the consumer for final verification.

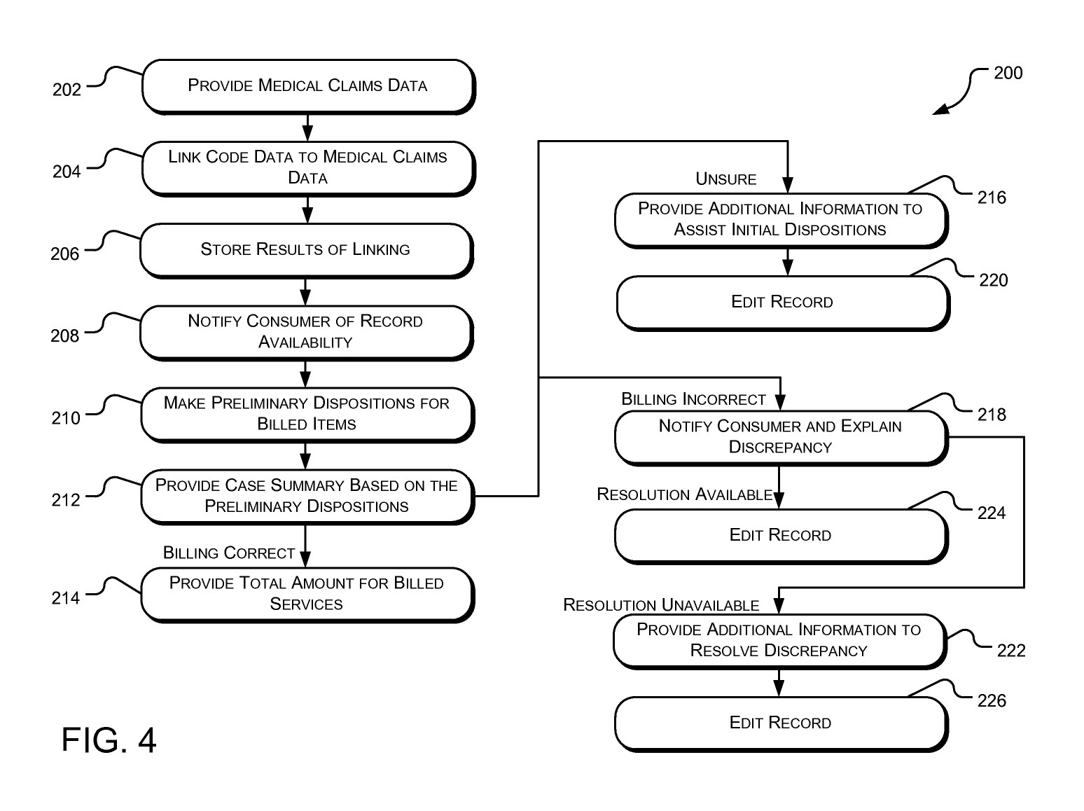

FIG. 4 is a flow chart illustrating example operations 200 for claim data verification. In one implementation, the claim verification process begins with an importing operation 202 that obtains paid medical claims data through a claim data acquisition engine or data feed. In a linking operation 204 and a storing operation 206, the medical claims data is integrated, joined or linked to the code interpretation/conversion data and stored, respectively. In one implementation, a medical claims database is updated with the joined data information. The claim verification database or medical claims database may be implemented using, for example, a relational database management system such as Microsoft® SQL Server. A notification operation 208 notifies the consumer about the availability of the joined data for review.

Following the notification, a disposition operation 210 allows the consumer to begin verifying the correctness of the medical services information for the services billed by a provider and making preliminary dispositions regarding billed services. In one implementation, the consumer may be presented with itemized claim information that includes a line-by-line breakdown of all services billed by a provider along with the corresponding code interpretation/conversion information. Stated differently, the actual claim information is displayed along with some other description of the services rendered, images (or links to images), and/or links to information that the subscriber can use to better understand the nature of the service being billed. The disposition operation 210 in such cases may involve a simple determination that the services submitted in the claim were in fact performed by a provider by making appropriate annotation or selections. For example, according to one implementation, each interpreted/converted description of a service or diagnosis code may include such verification options as “correct” or “verified”, “incorrect” or “billing discrepancy” and “unsure” or “unverified.” The verification options, according to one implementation, may be provided in a form of a box, radio button, or the like that the consumer may select, such as through clicking the appropriate selection or touching the screen over the appropriate selection, after reviewing a description of the service.

Alternatively, the disposition operation 210 may initially make a preliminary evaluation of the billed services and flag suspected billings to the consumer along with a number of follow-up questions to eliminate any potentially incorrect billings. In this case, the disposition operation 210 would dynamically learn to identify possible discrepancies based on the previously entered and analyzed data. Here, for example, the system may analyze the totality of billed services to identify groups of services, procedures, etc., that are normally grouped together and to identify service that may not be normally grouped, and highlight or otherwise provide some identification to the user of the discrepancy. Similarly, the system may highlight services, procedures, etc., that are not typically associated with males or females, younger or older patients, race, or preexisting conditions, and combinations thereof. So, for example, a bill for a statin type drug, normally associated with a patient with high cholesterol, may be flagged when a patient's record indicates normal cholesterol levels. In some instances, this automatic discrepancy analysis may not be undertaken until the user conducts an initial manual review so as to not give the subscriber the impression that other aspects of the bill, besides those highlighted, should not be checked.

Once the initial dispositions are made for all of the listed services associated with the claim (or payments already made), a summarizing operation 212 provides a summary of the consumer's selections for final review and verification. In particular, the summarizing operation 212 may present a summary of all previously selected dispositions along with any additional actions that may be available to the consumer to properly reconcile billed and actually rendered services. All billed services acknowledged by the consumer as being accurate and marked with “verified” or “correct” status may include such indication in the provided summary, in which case no further action would be required on the part of the consumer. Additionally, providing operation 214 provides a total amount for the verified services along with a “verified” or “correct” status indication.

On the other hand, a providing operation 216 provides assistance relating to all previously marked “unverified,” “not sure,” or “need assistance” dispositions that require further acknowledgement to make the initial disposition. For example, the “unverified” or “not sure” disposition may provide the consumer with additional options as to where assistance may be obtained in order to verify the billed medical service. Additionally, the providing operation 216 may provide the consumer with an opportunity to provide comments or be presented with choices regarding what action the consumer would like to take to confirm or verify the billed service. In the case of the “need assistance” disposition, the consumer may be provided with an option to contact the provider and request a time to speak with a representative, an option to contact the payer, or any other similar option that would assist the consumer with verifying the particular billed medical services. According to one implementation, a default follow-up notification, such as for example, email may be sent to consumer to update the case for all selected unresolved dispositions.

Similar to the “unverified,” “not sure,” or “need assistance” dispositions, any acknowledged billed charges that a consumer believes are incorrect, such as those marked with the “billing discrepancy” or “incorrect” status may also provide additional information or options for resolving discrepancies. In other words, in addition to being notified of the billing discrepancy identified during the verification process, a notifying operation 218 provides the consumer with an explanation of the discrepancy and additional options that indicate what actions the consumer prefers to take to resolve the potential billing discrepancy. More specifically, the consumer may be provided with an option to either correct the discrepancy by, for example, via an editing operation 220 to edit original selections or a providing operation 222 to provide instructions, help features and alternatives regarding how to resolve the potential billing discrepancies or errors. Also, operation 222 may provide the consumer with additional options to correct the discrepancies, such as: calling the provider or provider billing office; contacting the provider and/or payer via a formal letter; contacting the health plan or payer special Investigation unit (SIU); or having a clinical representative assist the consumer on a conference call with the patient accounts office to assist in a discrepancy resolution. Once there is a determination as to which action the consumer prefers to use to resolve the identified discrepancy, a request to update the discrepancy status will be made.

According to one implementation, for self-resolution and assistance requested, a request for update may be made, for example, every seven calendar days, or in the case of a formal letter, every thirty days. Editing operations 224 and 226 enable the consumer to access outstanding claims and provide updates based on additional information obtained or made available to the consumer for both the “billing discrepancy” and “not sure” dispositions or information that is made available to the consumer via the provider that provides a plausible explanation to resolve the dispute. Additionally, during this process, the consumer may be also prompted to explain why the initial disposition was incorrect to better understand opportunities to improve training or identify other trends.

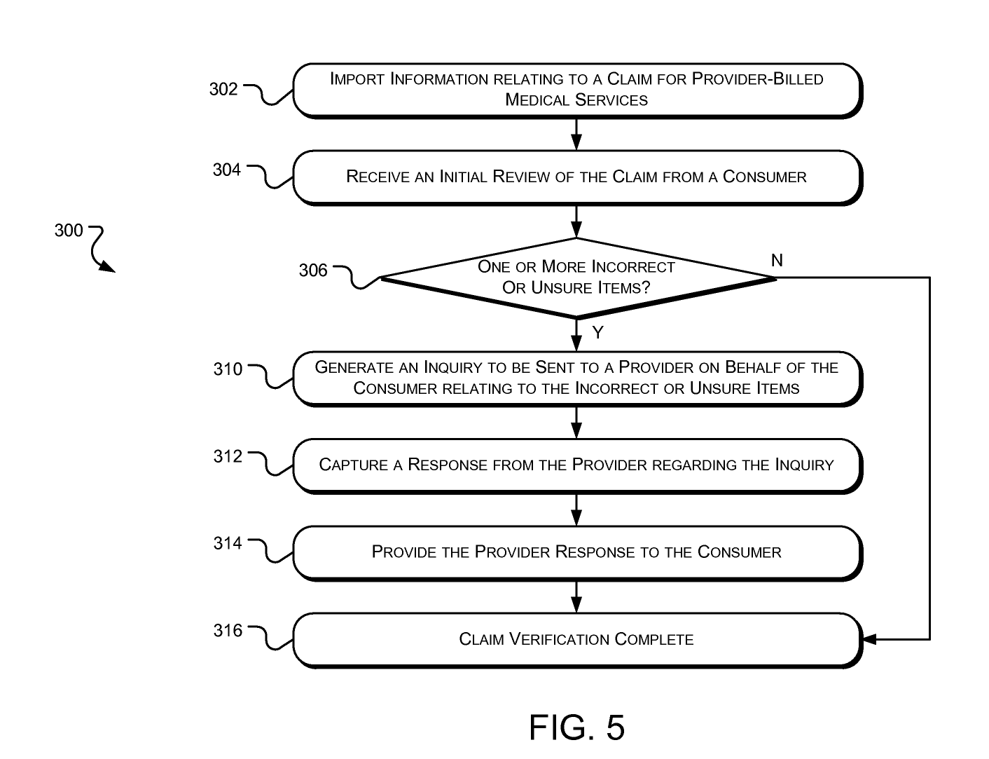

FIG. 5 is a flow chart illustrating example operations 300 for verifying a claim. In one implementation, an importing operation 302 creates a claim relating to provider-billed services for a consumer and imports associated information relating to the claim into a database, for example, using Secure File Transfer Protocol. In one implementation, the provider-billed services have been paid for and verification of the accuracy of the provider-billed services is requested. Verification may be requested based on a threshold set by an employer, consumer, or other interested party. The threshold may correspond to a monetary value paid for the provider-billed services and/or the nature of the provider-billed services. So, for example, through an administrative portal to the system, the employer or the like may set a threshold dollar amount above which requires verification by the user/subscriber. In one implementation, the importing operation 302 maps the imported information to corresponding data fields for easy use by a consumer or other user.

A receiving operation 304 receives an initial review of the claim by a consumer providing information relating to the accuracy of the provider-billed services. In one implementation, the initial review includes answers to a series questions relating to the provider-billed services, including a nature of the services. For example, the receiving operation 304 may include information regarding whether: the consumer received services from a healthcare facility and/or physician identified in the provider-billed services; the services were performed on or during a time indicated on the provider-billed services; and the bill type identified in the provider-billed services corresponds to actual services received by the consumer. Depending on this information, the receiving operation 304 may further include additional detail relating to itemized sections of provider-billed services where correction or additional detail is needed. In one implementation, the receiving operation 304 identifies items of the claim as correct, incorrect, or unknown (i.e., a consumer is unsure if the item is correct and additional information is needed to make the determination).

A deciding operation 306 determines whether one or more of the items of the claim are identified as incorrect or unknown. If no items of the claim are identified as incorrect or unknown (i.e., each of the items of the claim are identified as correct), a completing operation 314 completes the claim verification. Here, the user may select a button on the user interface indicating that the bill is correct, for example. If one or more items of the claim are identified as incorrect or unknown, a generating operation 308 generates an inquiry to be sent to the provider on behalf of the consumer with respect to the one or more items of the claim identified as incorrect or unknown. The inquiry may request correction of or information relating to the one or more items of the claim. In one implementation, the generating operation 308 generates a request letter providing the inquiry. The letter is prepopulated with all of the information necessary to determine whether or not the bill is correct, including the address of the medical provider, the name, date and other information pertinent to the patient and treatment date, the particulars of the bill, and the nature of the inquiry. Where no response is received from the provider regarding the inquiry, in one implementation, the generating operation 308 generates additional inquiries (e.g., two request follow up letters) to be sent to the provider on behalf of the consumer. During this time, the consumer may decide to no longer pursue the inquiry, and the completing operation 314 completes the claim verification. Alternatively, the consumer may take some other action to obtain the necessary information to verify the bill.

A capturing operation 310 captures a response from the provider regarding the inquiry. In one implementation, the capturing operation 310 captures the provider response based on information submitted by the provider directly to the consumer (e.g., via phone or letter), via an electronic form, and/or the like. Where the provider response is provided directly to the consumer, in one implementation, the capturing operation 310 captures the response based on information input by the consumer. So, for example, the consumer can enter the system and if they are now satisfied that the bill is correct, make the appropriate selection which will close the transaction within the system. A notes field may be provided where the user can type a short summary of the feedback from the provider that was sufficient for the consumer to resolve the issue.

In one implementation, the capturing operation 310 captures the provider response based on a provider response type, which includes agreeing with the inquiry fully or partially or disagreeing with the inquiry. A providing operation 312 presents the provider response to the consumer for review and any additional actions. In one implementation, where the provider agrees with the inquiry, the providing operation 312 will indicate actions the provider will take to resolve the claim, including providing information or corrections. For example, the provider may correct the claim with a charge reduction or refund. In this case, the providing operation 312 notifies the consumer of the refund to determine whether the refund was received and whether the amount is correct. The notification may be through an automatically populated field viewable through the user interface, in the form of an email, or by other means. The completing operation 314 completes the claim verification where the received refund is correct. If the received refund is incorrect or not received, the consumer may continue to dispute the claim.

Where the providing operation 312 notifies the consumer that the provider disagrees with the inquiry, partially or fully, the consumer may decide whether to continue pursuing the inquiry. If the consumer decides to no longer pursue the inquiry or is satisfied with the provider response, the completing operation 314 completes the claim verification. If the consumer decides to continue to pursue the inquiry, the generating operation 308 may generate additional follow up inquiries based on the information provided in the inquiry and/or any updates from the consumer. The operations 308-312 may repeat until the consumer decides to no longer pursue the inquiry or the consumer is satisfied with the provider response.

One or more of the operation 300 may correspond to rewards categories for the consumer. For example, the consumer may receive rewards points upon execution of the completing operation 314 and/or where a refund is received.

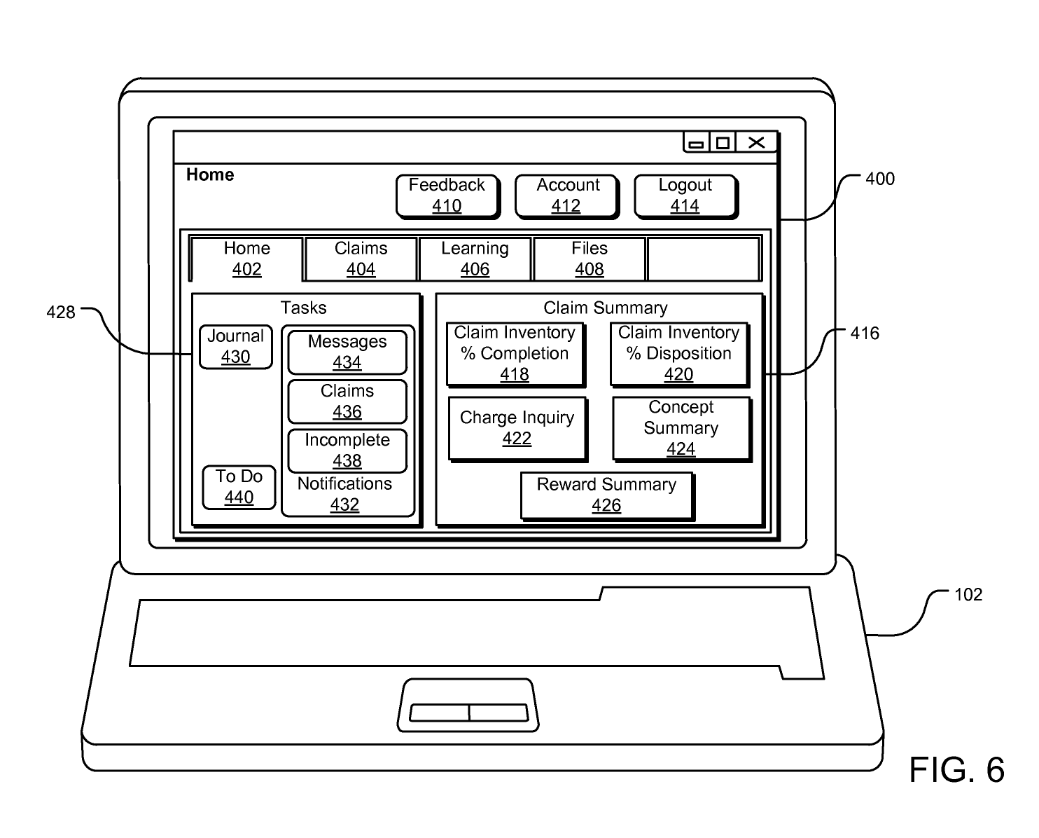

FIGS. 6-10 show the user interface 106 through which access to and interactions with healthcare cost information are controlled with the medical costs management application 124. It will be appreciated by those skilled in the art that such depictions are exemplary only and not intended to be limiting.

In one implementation, a user, such as a subscriber, participating dependent of the subscriber, employer, payer, provider, and/or another interested party, accesses the medical costs management application 124 via a link in a health plan account or payer intranet site using Single-Sign-On (SSO) methodology. In another implementation, the user connects directly to a homepage of the medical costs management application 124. However, other access methodologies and services are contemplated.

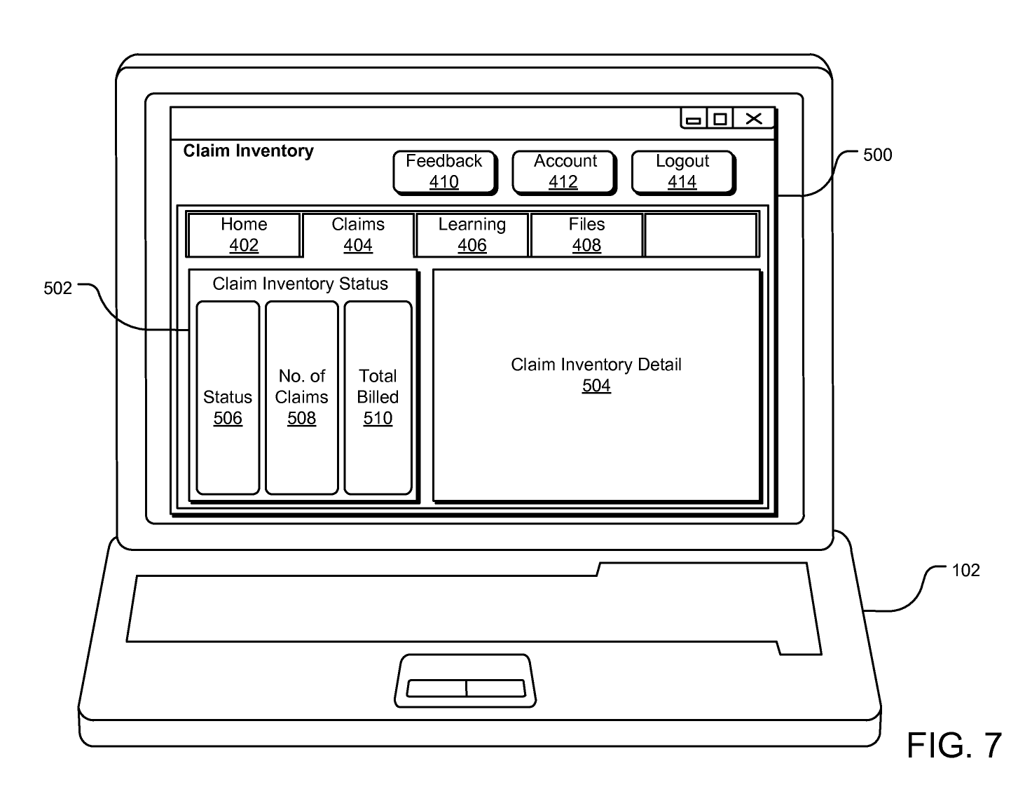

FIG. 6 shows a summary of consumer claim verifications on a consumer home page 400. In one implementation, the home page 400 provides links to consumer resources, information, services, and/or functions, including, without limitation, a home link 402, a claim center link 404, a concept center link 406, a file center link 408, a feedback link 410, a manage account link 412, and a logout link 514. The home link 402 directs the consumer to the home page 400, as shown in FIG. 6, and the claim center link 404 directs the consumer to a claim inventory page 500 as shown in FIG. 7.

In one implementation, the concept center link 406 directs the user to a concept center page, which assists consumers as they navigate the complexity of healthcare billing information and increases their sophistication as consumers of health services. The concept center page generally includes two activity groups: one group that introduces the healthcare cost management system and provides training on how to use the system and one group that educates the consumer about the healthcare system. As such, the concept center link 406 provides access to a variety of healthcare billing and administrative concepts, including, without limitation, current applicable laws or standards, healthcare system basics, billing codes and practices, healthcare claim life cycles, and the like. For example, such concepts may focus on: legal and professional standards involving patient rights, privacy and protection, and dispute resolution processes; charge entry, coding, and submission; bill types, revenue codes, procedure codes and modifiers, and Healthcare Common Procedure Coding codes and modifiers; and review, calculation, and payment of claims. From the concept center page, consumers may test their knowledge, for example, to meet requirements by health plans or payers, participate in a rewards program, and/or identify where further information or education is needed or desired.

The concept center page may organize the activity groups into sections listing activities completed and available, a percentage of activities completed, and a completion status of an activity. Further, in one implementation, the concept center page includes an achievement section displaying reward points earned from concept center activity, current achievement level, and a link to a next available activity, if applicable. Additionally, the concept center page may include a link to medical billing code descriptions and additional resources.

In one implementation, the file center link 408 directs the consumer to a file center page including a messages panel and a document panel. The message panel includes messages or notifications that were triggered systematically based upon certain events such as receipt of: a provider response through the electronic response portal, program messages, or plan messages. Messages may be displayed in a list with newest and unread messages on top of the list and/or highlighted in bold font. The document panel provides access to stored documents, such as request letters that have been sent to providers, documentation such as provider bill itemizations mailed or uploaded, concept center certificates, and the like. In one implementation, the panels include a list header displaying a date, case number, message subject, sender, and actions. Clicking on a message or document may open a pop-up message screen or window to allow viewing of the entire content.

The feedback link 410 and the manage account link 412 direct the consumer to a feedback page and a manage account page, respectively. The feedback page enables the consumer to provide feedback on the information, functions, and services of the healthcare cost management system, for example, by answering a survey or manually entering comments. The manage account page provides an interface for the consumer to manage account information. In one implementation, the manage account link 412 directs the consumer to account credentials, demographic information, and health plan information. Further, the manage account page may be used to show information pertaining to participating dependents.

As can be understood from FIG. 6, in one implementation, a claim summary 416 for each consumer (i.e., the subscriber and participating dependents) is displayed on the home page 400 as one or more visual summaries. The claim summary 416 may include graphical depictions of claims inventory (e.g., a claims inventory percentage completion 418 and a claims inventory percentage disposition 420) and a trending chart 422 of charges inquired upon by dollar by month for the plan period. As such, the home page 400 summarizes consumer claim verification activity.

Further, in one implementation, the home page 400 includes a concept center summary 424 displaying the consumer's current concept center achievements and a shortcut to the next activity and a reward summary 426 summarizing the consumer's progress in the reward program by displaying achieved and pending reward point activities and a link to the reward plan.

In one implementation, the home page 400 includes a task panel 428 displaying actionable items, such as a health journal link 430, a notification section 432, and a to do list 440. The health journal link 430 provides access to a health journal page or window through which the consumer may record personal comments or notes regarding their activities, services, health, or claim reviews. The notification section 432 displays program messages or notifications regarding the system 100, shortcuts to new messages 434, and outstanding claim inventory, including shortcuts to new claims 436 and incomplete claims 438. The to do list 440 is populated with items requiring the attention of the consumer and links for quick access and location of the items. For example, the to do list 440 may include a link to new claims and to update in-process claims, which correspond to one or more claims in-process in an incomplete status. The update in-process claims link directs the consumer to the claim inventory page 500, which may include claims filtered based on a link selected from the to do list 440. Further, the to do list 440 may include items relating to concept center activities with links to the next available activity and items prompting the consumer to update account information or add dependents.

Turning to FIG. 7, the claim inventory page 500 is shown listing all claims, which the consumer may select to review and/or verify a claim. In one implementation, the claim inventory page 500 includes a claim inventory status 502 and a claim inventory detail 504.

The claim inventory status 502 summarizes claims based on a status and disposition 506, a number of claims 508, and total dollars billed 510 displaying a number of claims and total dollars billed for each claim status and/or disposition. In one implementation, the status and disposition 506 includes incomplete, complete, and informational statuses.

The incomplete status includes new claims that have imported into the system 100, claims where a review has been initiated by the consumer and not yet completed, and claims where verification has been completed by the completed, however final resolution has not yet been reached. The incomplete status includes dispositions, such as: “New” (new claim inventory): “Under Review” (a review is in process with actionable disposition); “First Request for Information” (a review is in process with a first request for information letter sent to provider); “Second Request for Information” (a review is in process with a second request for information letter sent to provider); “Third Request for Information” (a review is in process with a third request for information letter sent to provider); “First Request for Correction” (a review is in process with a first request for correction letter sent to provider); “Second Request for Correction” (a review is in process with a second request for correction letter sent to provider); “Third Request for Correction” (a review is in process with a third request for correction letter sent to provider); “Request Continued” (a review is in process; with the consumer continuing an inquiry); “Refund Expected” (verification is pending waiting for receipt and posting of provider refund to the claim).

The complete status includes claims where the verification process was completed and a final resolution was reached. The complete status includes dispositions, such as: “Correct” (the verification is final with no errors found or confirmed); “Provider Unresponsive” (the verification is final but the provider was unresponsive to the consumer inquiry); “Request Abandoned” (the verification is final but the consumer halted the inquiry); “Refund Received” ((the verification is final and the provider refund is posted to the claim).

The informational status includes claims, such as exact duplicate non-paid claims, claim denials, low-dollar threshold claims as defined by the employer or payer, and “Exempt” claims as defined by the employer or payer).

The claim inventory detail 504 lists the claims for a selected consumer based on the statuses and dispositions 406. Additionally, the consumer may select claims inventory to view by all consumers, (self and all proxy-authorized dependent consumers), self, and any individual proxy-authorized dependent consumers. Consumer and claim status selection drives what data is generated in the claim inventory detail 504. The claim listing displayed in the claim inventory detail 504 may be include information, such as patient name, date of service, provider name, claim number, total billed, disposition, last action, and last action date. The consumer may sort the claim inventory detail 504 by any of this information. By clicking on a line item in the claim inventory detail 504, the consumer will be directed to a claim review page 600 to begin the verification process.

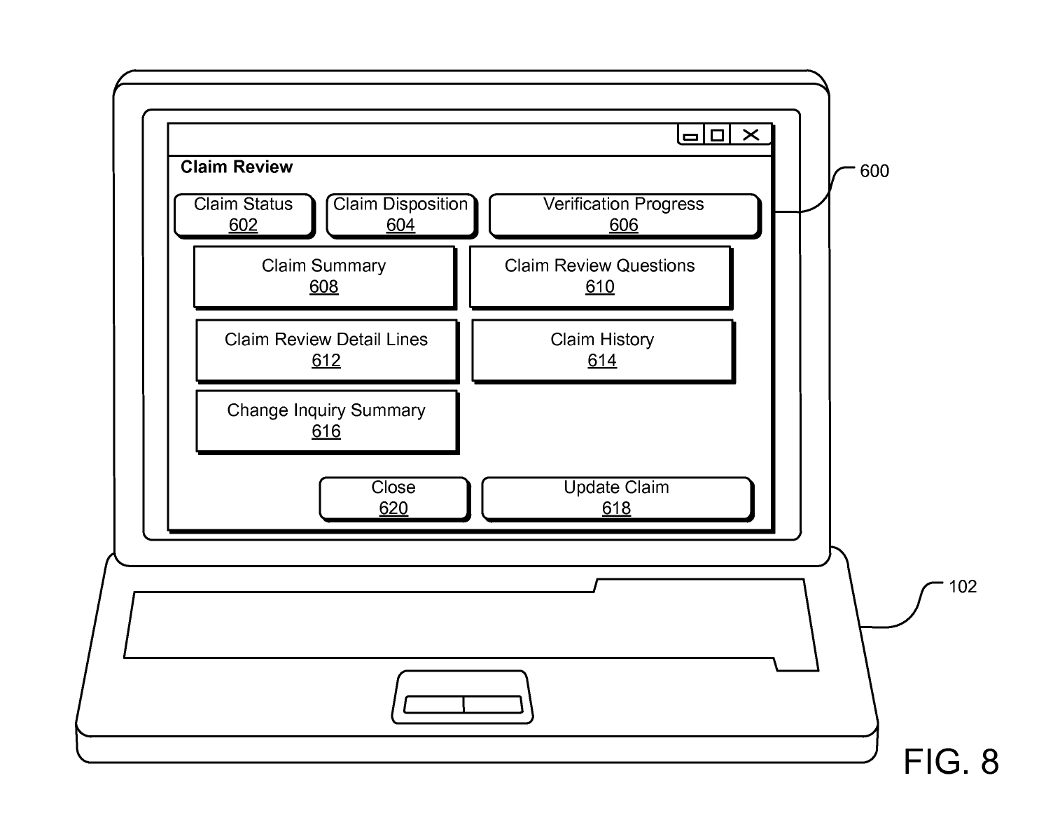

Referring to FIG. 8, the claim review page 600 is shown, which displays details of a claim and guides the consumer through the verification process. The claim review page 600 shows a status 602 and a disposition 604 of the claim and a verification progress 606. The verification progress 606 may be displayed in the form of a progress bar having different segments depending on the claim verification path chosen by the consumer. The segments of the progress bar may be highlighted once a phase corresponding to the segment is complete.

In one implementation, the verification process utilized by the claim review page 600 is dictated by the level of concept center achievement and/or consumer or employer preferences. Stated differently, varying levels of detail is displayed with respect to the claim based on the knowledge and sophistication of the consumer.

In one implementation, the claim review page 600 includes a claim summary 608, claim review questions 610, claim review detail lines 612, a claim history 614, and a charge inquiry summary 616.

The claim summary 608 includes demographic information pertaining to the claim such as: patient name, subscriber ID number, member ID number, claim number, facility/physician group name and NPI number, physician name and NPI number, date of service, patient account number, and bill type for institutional claims.

The claim review questions 610 relate to whether services were performed during the indicated date span and the nature of the actual services as compared to the billed services. In one implementation, the claim review questions 610 ask the consumer whether: 1) the patient received services from this healthcare facility or physician; 2) the services were performed on or during the date span indicated; and 3) the provider's bill type corresponds to the nature of the actual services.

In one implementation, the consumer may select answers in the claim review questions 610 as either “Yes” or “No” or the like to the first two questions. If the consumer answers “No” to the first question, all further questions will be auto-populated as “No” and claim lines marked as “Incorrect” and reason codes selected as “Billed service was not performed.” “No” answers will trigger specific language in a generated inquiry letter.

The claim review details lines 612 contains a charge line itemization of the claim including: line number, date of service, revenue code, procedure code, modifier, units (quantity), billed amount, allowed amount, patient liability, paid amount, and paid date. The total dollar amounts billed, allowed, patient liability, and paid may be displayed for the claim under the charge line itemization. In one implementation, the bill type, revenue code, procedure code, and/or modifier may be selected to obtain an interpretation, definition, or further explanation.

In the claim review details lines 612, the consumer selects from three mutually exclusive answer options: “Correct,” “Incorrect,” and “Unsure.” Each line item will conclude with a reason type. The consumer will be prompted for selecting a reason type where the “Incorrect” or “Unsure” answers are selected for an item. Available reason types are dictated by the answers selected, the nature of the services, billing codes, and/or other information. In one implementation, the reason types available for an “Incorrect” answer include: billed service incorrect or not performed; incorrect level of service billed; and incorrect quantity billed, and the reason types available for an “Unsure” answer include: request clarification for charge; request an itemization for charge; and review at a later time.

In one implementation, as individual claim line Items are verified or disputed, a total of the “Billed” dollar amounts for all questioned claim lines will be displayed on the charge inquiry summary 616. Based on the input from the consumer, an inquiry letter, detailing questioned items from the claim and requesting information or charge correction, will be generated to be sent to the provider on behalf of the consumer or the claim verification is completed. The consumer may preview and edit the inquiry letter prior to submission.

In one implementation, the inquiry letter contains the patient name and contact information, the provider name and contact information, standard template text, custom comments entered by the consumer, added pages detailing the claim items, authorization to interface via the system 100 on matters relating to the claim, and case and pin numbers to identify the claim. An update claim button 618 allows the consumer to update the claim or provide a provider response after the inquiry letter is sent. A close button 620 permits the consumer to complete a claim review or stop, save, and resume the claim review at a later time. The history of the claim and any notifications or updates are displayed in the claim history 614.

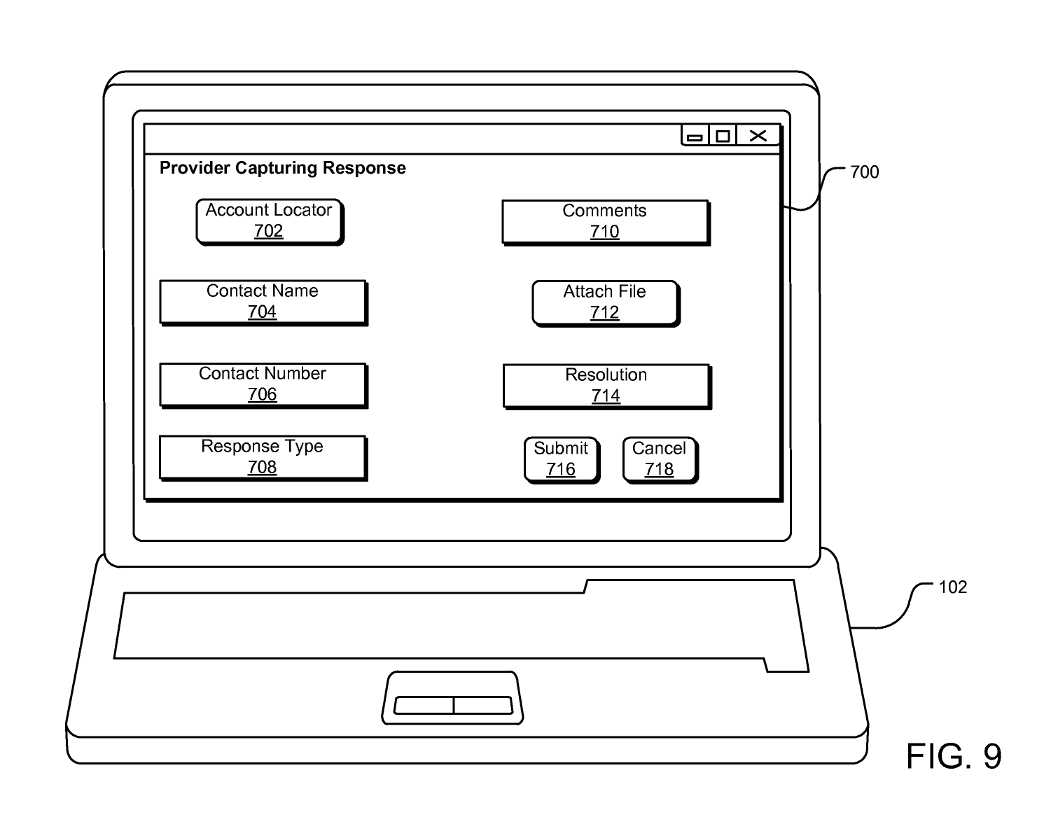

FIG. 9 illustrates a provider capturing response window 700 with which a provider may respond to consumer claim requests. In one implementation, the provider enters the case and pin number identified in the inquiry letter into an account locator 702 to verify and retrieve information relating to the inquiry. The provider capturing response window 700 enables the provider to submit information in data fields, including, but not limited to, a contact name field 704, a contact phone number field 706, a response type field 708 (e.g., agree with consumer, partially or in full, or disagree with consumer), a comments field 710, supporting file attachment 712, a resolution field 714, The resolution field 714 may include additional fields, such as a charge reductions field, a refund amount field, including a check number field, and a date field. A submit button 716 submits the provider response and the cancel button 718 cancels the submission.

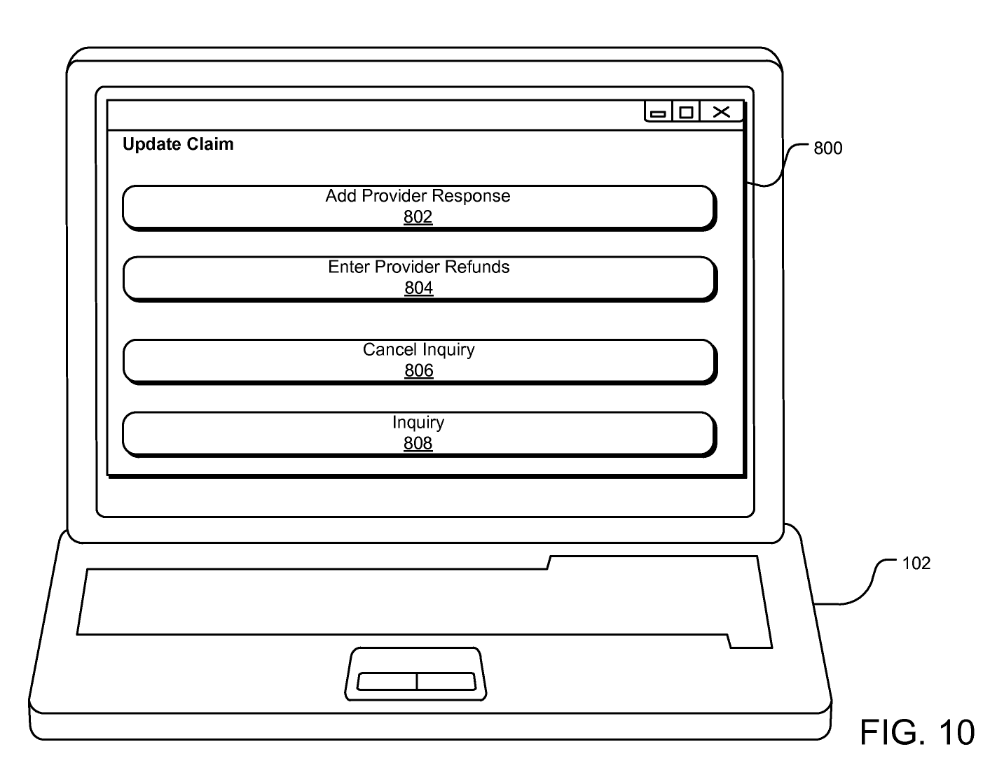

FIG. 10 shows an updating claim window 800. In one implementation, the updating claim window 800 includes an add provider response link 802, an enter provider refunds link 804, a cancel inquiry link 806, and an inquiry link 808. With the add provider response link 802, the consumer may enter information received from a provider in response to an inquiry. For example, the provider may contact the consumer directly via telephone or letter. Selection of the add provider response link 802 will prompt the consumer to provide a date of the interaction with the provider, any comments, any documents sent by the provider, and a response type. The response type may be that the provider agrees with the inquiry or disagrees with the inquiry, partially or fully.

The enter provider funds link 804 provides the consumer with an option of entering a reimbursement to the payer or a reduction of patient liability. A date, amount, check number, and any comments are entered via the enter provider funds link 804.

The cancel inquiry link 806 may be selected where the consumer no longer desires to pursue the inquiry on the claim or the consumer is satisfied with the provider response. The consumer will be prompted to provide a reason, including, for example, that: prior to receiving the provider response, the consumer determined the previously inquired upon items were correct; the consumer never received a provider response but no longer desires to pursue the inquiry; after receiving the provider response, the consumer determined that the previously inquired upon items were correct; or the consumer disagrees with the provider response but no longer desires to pursue the inquiry. The inquiry link 808 provides the consumer with options to generate and send follow up inquiries on the claim until the claim verification is complete.

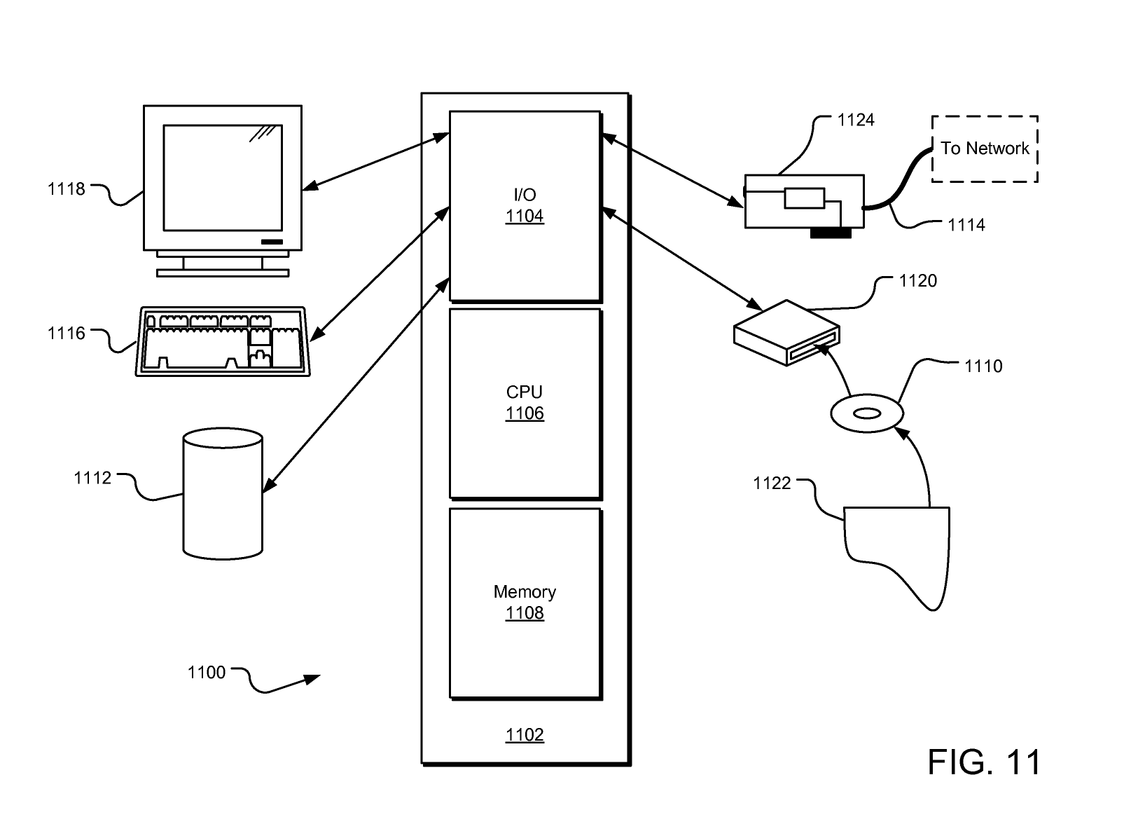

FIG. 11 is an example computing system 1100 that may implement various systems and methods discussed herein. A general purpose computer system 1100 is capable of executing a computer program product to execute a computer process. Data and program files may be input to the computer system 1100, which reads the files and executes the programs therein. Some of the elements of a general purpose computer system 1100 are shown in FIG. 11 wherein a processor 1102 is shown having an input/output (I/O) section 1104, a Central Processing Unit (CPU) 1106, and a memory section 1108. There may be one or more processors 1102, such that the processor 1102 of the computer system 1100 comprises a single central-processing unit 1106, or a plurality of processing units, commonly referred to as a parallel processing environment. The computer system 1100 may be a conventional computer, a distributed computer, or any other type of computer, such as one or more external computers made available via a cloud computing architecture. The presently described technology is optionally implemented in software devices loaded in memory 1108, stored on a configured DVD/CD-ROM 1110 or storage unit 1112, and/or communicated via a wired or wireless network link 1114, thereby transforming the computer system 1100 in FIG. 11 to a special purpose machine for implementing the described operations.

The I/O section 1104 is connected to one or more user-interface devices (e.g., a keyboard 1116 and a display unit 1118), a disc storage unit 1112, and a disc drive unit 1120. Generally, the disc drive unit 1120 is a DVD/CD-ROM drive unit capable of reading the DVD/CD-ROM medium 1110, which typically contains programs and data 1122. Computer program products containing mechanisms to effectuate the systems and methods in accordance with the presently described technology may reside in the memory section 1104, on a disc storage unit 1112, on the DVD/CD-ROM medium 1110 of the computer system 1100, or on external storage devices made available via a cloud computing architecture with such computer program products, including one or more database management products, web server products, application server products, and/or other additional software components. Alternatively, a disc drive unit 1120 may be replaced or supplemented by a floppy drive unit, a tape drive unit, or other storage medium drive unit. The network adapter 1124 is capable of connecting the computer system 1100 to a network via the network link 1114, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 1100 is connected (by wired connection or wirelessly) to a local network through the network interface or adapter 1124, which is one type of communications device. When used in a WAN-networking environment, the computer system 1100 typically includes a modem, a network adapter, or any other type of communications device for establishing communications over the wide area network. In a networked environment, program modules depicted relative to the computer system 1100 or portions thereof, may be stored in a remote memory storage device. It is appreciated that the network connections shown are examples of communications devices for and other means of establishing a communications link between the computers may be used.

In an example implementation, healthcare cost data, the medical costs management application 124, a plurality of internal and external databases, source databases, and/or data cache on cloud servers are stored as the memory 1108 or other storage systems, such as the disk storage unit 1112 or the DVD/CD-ROM medium 1110, and/or other external storage devices made available and accessible via a cloud computing architecture. Healthcare cost management and claim verification software and other modules and services may be embodied by instructions stored on such storage systems and executed by the processor 1102.

Some or all of the operations described herein may be performed by the processor 1102. Further, local computing systems, remote data sources and/or services, and other associated logic represent firmware, hardware, and/or software configured to control operations of the management system 100. Such services may be implemented using a general purpose computer and specialized software (such as a server executing service software), a special purpose computing system and specialized software (such as a mobile device or network appliance executing service software), or other computing configurations. In addition, one or more functionalities of the management system 100 disclosed herein may be generated by the processor 1102 and a user may interact with a Graphical User Interface (GUI) using one or more user-interface devices (e.g., the keyboard 4916, the display unit 1118, and the user devices 1104) with some of the data in use directly coming from online sources and data stores. The system set forth in FIG. 11 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for healthcare cost management, the method comprising:
importing information into a database using a network component, the information relating to a claim involving provider-billed medical services for a consumer;
receiving an initial review of the accuracy of one or more items of the claim by the consumer at a server, the initial review identifying an accuracy of the one or more items of the claim; and
verifying the claim based on the identified accuracy of the one or more items of the clam.

2. The method of claim 1 further comprising:
prompting the consumer to review an accuracy of the one or more items of the claim; and
transmitting an inquiry to the provider regarding the claim.

3. The method of claim 1, wherein the information is linked to code interpretation data.

4. The method of claim 3, wherein at least one of the items corresponds to the code interpretation data.

5. The method of claim 1, wherein the initial review includes a response to a survey regarding the billed medical services.

6. The method of claim 5, wherein the survey has questions including at least one of: whether the consumer received any services from the provider; whether the billed services were performed during a time indicated by the provider; or whether a bill type identified by the provider for the billed services corresponds to the actual services.

7. The method of claim 1, wherein the initial review identifies each of the one or more items as correct, incorrect, or unknown.

8. The method of claim 7, wherein the claim is verified as complete when each of the one or more items is identified as correct.

9. The method of claim 8, wherein the claim is verified as incomplete where at least one of the one or more items is identified as incorrect or unknown.

10. The method of claim 1, further comprising:
generating the inquiry to be sent to a provider on behalf of the consumer, the inquiry relating to the at least one item identified as incorrect or unknown.

11. The method of claim 10, wherein the inquiry requests information from the provider where the at least one item is identified as unknown and the inquiry requests correction by the provider where the at least one item is identified as incorrect.

12. The method of claim 11, wherein the requested correction is a refund.

13. The method of claim 9, further comprising:
capturing a response from the provider regarding the inquiry; and
notifying the consumer of the provider response.

14. The method of claim 13, wherein the claim is verified according to the provider response.

15. One or more tangible computer-readable storage media storing computer-executable instructions for performing a computer process on a computing system, the computer process comprising:
importing information into a database using a network component, the information relating to a claim involving provider-billed medical services for a consumer;
receiving an initial review of the claim by the consumer at a server, the initial review identifying an accuracy of one or more items of the claim; and
receiving a status of the of the claim based on the initial review, the status dictating whether an inquiry is sent to the provider regarding the claim.

16. The one or more tangible computer-readable storage media storing computer-executable instructions for performing a computer process on a computing system, the computer process of claim 15 comprising:
prompting the consumer to review an accuracy of one or more items of the provider-medical service;
capturing a response from the provider regarding the inquiry; and
notifying the consumer of the response.

17. A system for healthcare cost management, the system comprising:
a medical cost management application running on a server having a processing device and memory accessible by a client system over a network, the medical cost management application stored in the memory as computer executable instructions, and configured to verify a claim involving provider-billed medical services for a consumer based on an accuracy of one or more items of the provider-billed medical services, the accuracy based on an initial review by the consumer.

18. The system of claim 17 further comprising the computer executable instructions configured to:
receive an identification as to whether one or more items of the claim correspond to actual services performed by the provider; and
transmitting an inquiry to the provider concerning the claim.

19. The system of claim 17, wherein the processing device is further configured to execute instructions stored in the memory to generate a learning session to educate the consumer regarding healthcare cost management.

20. The system of claim 17, wherein the processing device is further configured to execute instructions stored in the memory to track rewards associated with at least one consumer action.

21. The system of claim 20, wherein the rewards correspond to a point-based reward program.

22. The system of claim 20, wherein the rewards correspond to a one-time reward.

23. The system of claim 17, the processing device is further configured to execute instructions stored in the memory to link information associated with the claim with billing code interpretation data to assist the consumer.
